(19) United States
(12) Patent Application Publication
(10) Pub. No.: US 2015/0044118 A1
(43) Pub. Date: Feb. 12, 2015

(54) LOW-CHLORIDE LIPF6

(71) Applicant: LANXESS Deutschland GmbH, Cologne (DE)

(72) Inventors: Matthias Boll, Cologne (DE); Wolfgang Ebenbeck, Leverkusen (DE); Eberhard Kuckert, Leverkusen (DE)

(21) Appl. No.: 14/372,080

(22) PCT Filed: Jan. 18, 2013
(86) PCT No.: PCT/EP2013/050966

§ 371 Date: Oct. 1, 2014

(30) Foreign Application Priority Data
Jan. 19, 2012 (EP) 12151751.0

(51) Int. Cl. C01D 15/00; B01J 19/24

(52) U.S. Cl. CPC C01D 15/005; B01J 19/242; B01J 2219/00306; B01J 2219/0075
USPC 423/301; 422/636; 422/146

(57) ABSTRACT

The present invention relates to a process for preparing low-chloride LiPF₆, in particular low-chloride LiPF₆ solutions, from PCl₃ as starting material and via PCl₅ as intermediate product, and also to apparatus to be used for this.

The present invention relates to a process for preparing low-chloride LiPF₆, in particular in the form of low-chloride LiPF₆ solutions, from PCl₃ as starting material and via PCl₅ as intermediate product, and also to apparatus to be used for this.

Numerous processes for preparing LiPF₆ are described in the prior art. Specific technical circumstances, however, require specific versions of processes. The following reaction sequence is on offer when PCl₃ and HF are available:

PCl₃+3HF→PF₃+3HCl step 1

PF₃+Cl₂→PCl₂F₃ step 2

PCl₂F₃+2HF→PF₅+2HCl step 3

PF₅+LiF→LiPF₆ step 4

Seeking a low PF₃ content level in the end product, DE 197 12 988 A1 describes a batch process in an autoclave proceeding from PCl₃. An initial 7.8 g charge of LiF in a dry experimental reactor made of stainless steel was heated at 150° C. under argon. An initial charge of PCl₃ in a laboratory autoclave was cooled down to −52° C., at which point HF was metered in. After cooling down to −58° C., the Cl₂ was metered in, The autoclave was then removed from the cooling bath and an HCl—PF₅ gas mixture was passed over the LiF in the experimental reactor. On completion of the passing-over of the gas mixture, a further 7.8 g of LiF were introduced into the experimental reactor to add to the LiPF₆ formed. Another HCl—PF₅ gas mixture was produced similarly to the manner described above and passed over the LiPF₆-LiF mixture in the experimental reactor. The LiPF₆ obtained was highly crystalline and subdivisible in a mortar without evolution of visible vapours.

DE 19722269 A1 describes not only a batch process but also a process involving continuous admixture of chlorine in an autoclave based on PCl₃. The starting materials used were phosphorus trichloride: mass: 61.8 g=0.45 mol of hydrogen fluoride (high purity): mass: 96.9 g=3.84 mol, for reaction with the PCl₃: excess of 1.59 mol=70.7% and also chlorine/Cl₂: mass: 40.0 g=0.56 mol. The vessels used were dried in a drying cabinet. The laboratory autoclave was initially charged with the phosphorus triehloride, and more than the equivalent amount of hydrogen fluoride needed was gradually metered in (with N₂ cushion), the excess of HF serving as solvent.

The temperatures in the laboratory autoclave during the subsequent continuous addition of chlorine in an open system (duration: 355 min) were between −65.7° C. and −21.7° C. Agus mixture of PF₅ and HCl formed during the metered addition of the chlorine, and was removed from the autoclave. The mixture was separated using customary methods of separation, for example pressure distillation.

In a further example of the same prior art, the PCl₃ was metered into the autoclave, which was then sealed. The autoclave was cooled down to −57.6° C., at which point the hydrogen fluoride was added, followed by further cooling to −59.3° C. At this point, the chlorine was admixed. The cooling was then removed, and pressure built up to 43 bar at 25.1° C. The resultant gas mixture of PF₅ and HCl was vented out of the autoclave and did not require any further treatment before being introduced into a reactor containing LiF, in which LiPF₆ then formed. No PF₃ was detected in the gas mixture.

Likewise proceeding from PCl₃ and chlorine, CN 101723348 A describes a process for preparing LiPF₆ in the liquid phase wherein HF acts as solvent and the reaction of the PCl₃/HF/HCl mixture with Cl₂ is carried out at 35-70° C. and the reaction of PF₅ with LiF at −30 to −10°C.

JP11171518 A2 likewise describes a process for preparing LiPF₆ from PCl₃ and HF to prepare PF₃ therefrom and convert it with Cl₂ into PCl₂F₃, the conversion thereof in turn with HF to form PF₅ and finally the reaction of PF₅ with LiF to form LiPF₆ in an organic solvent. Diethyl ether and dimethyl carbonate are used as solvents. Although JP 11171518 A2 notes the production of toxic HCl gas, there is no indication in the prior art of the presence of chloride in the LiFF₆.

This is mentioned because traces of chloride due to the by-produced HCl as well as traces of fluoride have been found to combine with moisture/water to produce corrosive damage in electrochemical storage devices based on LiFF₆.

The problem addressed by the present invention was therefore that of developing a process which proceeds from PCl₃ and utilizes HF and Cl₂ to lead to a solution of LiPF₆ in an organic solvent, or a mixture of two or more organic solvents, having a chloride content <100 ppm, preferably <50 ppm, and more preferably <5 ppm, which can be further processed into an electrolyte suitable for electrochemical storage devices. Chloride contents below 100 ppm are “low-chloride” for the purposes of the present invention.

The problem is solved according to the present invention by a process for preparing LiPF₆ solutions in an organic solvent, or a mixture of two or more organic solvents, proceeding from PCl₃, which is first reacted continuously in the gas phase with HF to form a PF₃-containina reaction mixture which in turn is reacted continuously in the gas phase with Cl₂ initially to forma PCl₂F₃-containing reaction mixture and with additional HF to form a PF₅-containinz reaction mixture, characterized in that the PF₅-containing reaction mixture is finally reacted in a fixed bed reactor or fluidized bed reactor over LiF mouldings or with an LiF powder, for example ground or unground, and/or an LiFxHF adduct, for example ground or unground, and the reaction product is washed with an organic solvent out of the fixed bed reactor or the fluidized bed reactor and isolated. A fluidized bed reactor herein is also referred to, for short, as fluidized bed. Employing a fixed bed reactor is preferable according to the present invention.

The fact that when PF₅ is reacted with LiF in a fixed bed reactor or in a fluidized bed it reacts with LiF in solid form leads, surprisingly, to a low-chloride LiPF₆ solution after the reaction product has been dissolved in an organic solvent or in a mixture of two or more organic solvents.

The purview of the invention encompasses all the definitions and parameters recited hereinbelow in general terms or in preferred ranges in any combinations.

In a further preferred embodiment, the PF₅-containing reaction mixture is temperature regulated to temperatures of −50 to +200° C. before entry into the fixed bed reactor or into the fluidized bed, preferably of −20 to +90° C., more preferably of −20 to +50° C. and most preferably of −10 to 30° C.

In a further preferred embodiment, LiF mouldings used in the fixed bed reactor or in the fluidized bed are prepared beforehand by extrusion from a mixture of LiF and water wherein the solids content is in the range from 20 to 95 wt %, preferably in the range from 60 to 90 wt % and more preferably about 70 wt %, and after extrusion these mouldings are dried at temperatures of 50 to 200° C., preferably at temperatures of 80 to 150° C. and more preferably at about 120° C. and they merely retain a water content of 0.05 to 5 wt %, preferably of 0.1 to 0.5 wt %, wherein the water content is determined by the method of Karl Fischer, which is known to a person skilled in the art and is described for example in P. Bruttel, R. Schlink, Wasserbestimmung durch Karl-Fischer-Titration, Metrohm monograph 8.026.5001, 2003-06, or G. Wieland, Wasserbestimmung durch Karl-Fischer-Titration, GIT Verlag Darmstadt, 1985.

In one preferred embodiment, the LiF is employed in the form of mouldings or in the form of fine particles having a particle size distribution in the range from 5 to 500 μm. The reaction may selectively be carried out in the form of a fixed bed, but also as fluidized bed or stirred fluidized bed; all embodiments are known to a person skilled in the art.

In one preferred embodiment, the gas mixture emerging from the fixed bed reactor or the fluidized bed is trapped in an aqueous solution of alkali metal hydroxide, preferably an aqueous solution of KOH and more preferably in a 5 to 30 wt %, even more preferably in a 10 to 20 wt %, especially preferably in a 15 wt %, KOH solution in water.

According to the invention, the reaction product is dissolved out of the fixed bed reactor or the fluidized bed with an organic solvent or a mixture of two or more organic solvents and, if necessary, by removal of solids preferably via a filtration or via centrifugation of undissolved constituents, separated off. Further possibilities of solids removal are known to a person skilled in the art.

Preferably, the dissolving and the perhaps necessary solids removal is carried out after the fixed bed reactor or the fluidized bed has been purged with an inert gas to thereby remove the reactive gas.

To dissolve the resultant LiPF₆, the reactor contents of the fixed bed reactor or of the fluidized bed are brought into contact with an organic solvent, or a mixture of two or more organic solvents, for a period of 5 minutes to 24 hours, more preferably for a period of 1 hour to 5 hours, preferably under stirring or under pumped recirculation, until the LiPF₆ content of the solvent or solvent mixture, as plotted versus the contact time, is constant.

Organic solvents preferred for employment according to the present invention are room temperature liquid organic nitriles or liquid organic carbonates or mixtures thereof.

It is particularly preferable for the liquid organic nitrile used to be acetonitrile.

It is particularly preferable for the liquid organic carbonate used to be dimethyl carbonate (DMC) or diethyl carbonate (DEC) or propylene carbonate (PC) or ethylene carbonate (EC) or a mixture of two or more thereof. Employment of dimethyl carbonate is especially preferred.

The organic solvent to be used is preferably subjected before use to a drying process, more preferably a drying process over a molecular sieve.

Molecular sieves which according to the present invention are preferably employed for drying consist of zeolites.

Zeolites are crystalline aluminosilicates, numerous forms of which occur in nature but are also obtainable synthetically. More than 150 different zeolites have been synthesized, 48 naturally occurring zeolites are known. Mineralogists think of natural zeolites as members of the zeolite group.

The composition of the zeolite group of minerals is:

Mⁿ⁺_{x/n}[AlO₂)ₓ(SiO₂)]·zH₂O
The factor n is the charge on the cation M and is preferably 1 or 2.
M is preferably a cation of an alkali or alkaline earth metal. These cations are needed to neutralize the negatively charged aluminium tetrahedra, and are not incorporated in the main lattice of the crystal, but reside in void spaces of the lattice and therefore are also extremely mobile within the lattice and also post-exchangeable.
The factor z indicates how many water molecules have been imbibed by the crystal. Zeolites are capable of imbibing water and other low-molecular-weight entities and releasing them again on heating without destruction of their crystalline structure in the process.
The molar ratio of SiO₂ to AlO₂, or x/y in the empirical formula, is known as the modulus. By Löwenstein's rule, it can never be less than 1.

According to the present invention, preferred synthetic zeolites for use as molecular sieves are:

| Zeolite | Composition of unit cell |
|---|---|
| zeolite A | Na₁₂[(AlO₂)₁₂(SiO₂)₁₂]•27 H₂O |
| zeolite X | Na₈₆[(AlO₂)₈₆(SiO₂)₁₀₆]•264 H₂O |
| zeolite Y | Na₅₆[(AlO₂)₈₆(SiO₂)₁₃₆]•250 H₂O |
| zeolite L | K₉[(AlO₂)₉(SiO₂)₂₇]•22 H₂O |
| mordenite | Na_{8.7}[(AlO₂)₈₆(SiO₂)_{39.3}]•24 H₂O |
| ZSM 5 | Na_{0.3}H_{3.8}[(AlO₂)_{4.1}(SiO₂)_{91.9}] |
| ZSM 11 | Na_{0.1}H_{1.7}[(AlO₂)_{1.8}(SiO₂)_{94.2}] |

The LiPF₆-containing organic solvent generally further comprises fractions of unconverted LiF, which is removed from the organic solvent in the form of a solid.

Removal is preferably by filtration, sedimentation, centrifugation or flotation, more preferably by filtration, even more preferably by filtration through a filter having an average pore size of 200 nm or less. The removed LiF can be dried and returned back into the reaction with PF₅.

The reactors to be used for the continuous process of preparing the PF₅ in the gas phase, preferably tubular reactors, especially stainless steel tubes, and also the fixed bed reactor to be used for synthesizing the LiPF₆ or the fluidized bed are known to a person skilled in the art and described for example in Lehrbuch der Technischen Charlie—Volume 1, Chemische Reaktionstechnik, M. Baerns, H. Hofmann, A. Renken, Georg Thieme Verlag Stuttgart (1987), pp. 249-256.

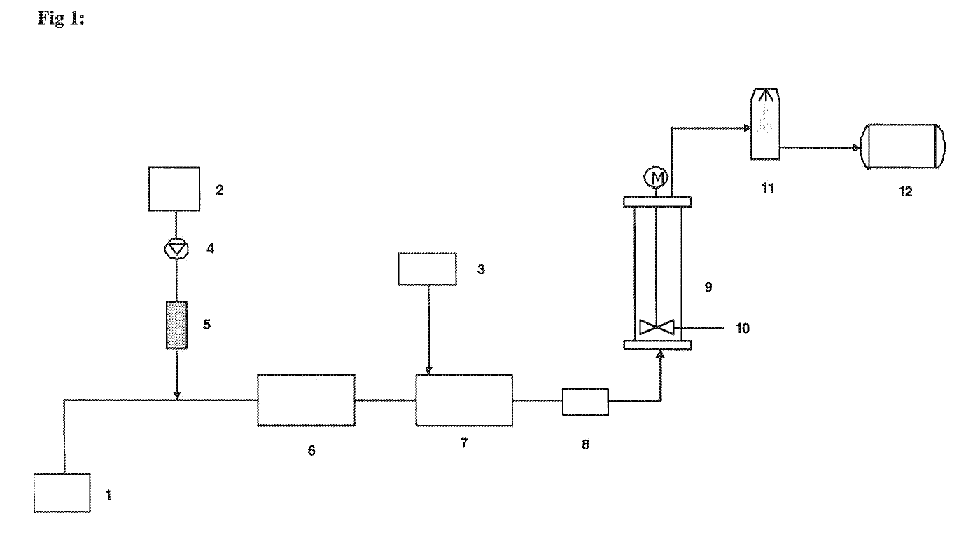

The apparatus used in the course of the present work likewise forms part of the subject-matter of the present invention. It will be described with reference to FIG. 1. The reference signs and their referents in FIG. 1 are

1 initial charge of temperature-regulated anhydrous HF with mass flow controller

2 2 initial charge of PCl₃

3 initial charge of Cl₂

4 pump

5 PCl₃ vaporizer

6 stainless steel tube

7 stainless steel tube

8 heat exchanger

9 fixed bed reactor (alternatively, fluidized bed reactor)

10 stirrer

11 scrubber

12 disposal container

What is essential to the present invention is in particular the combination of initially at least two serially connected tubular reactors, preferably stainless steel tube 6 and stainless steel tube 7, to prepare the PF₅ in combination via at least a heat exchanger with at least a fixed bed reactor or fluidized bed reactor in which the reaction of the PF₅ and finally over solid LiF to form LiPF₆ then takes place.

The present invention accordingly provides an apparatus for preparing LiPF₆, preferably LiPF₆ solutions, and the intermediate product PF₅ from PCl₃, characterized in that at least two tubular reactors, preferably two stainless steel tubes, are combined to prepare the PF₅ and are in turn combined with at least a fixed bed reactor or fluidized bed reactor, preferably a fixed bed reactor, via at least a heat exchanger to prepare the LiPF₆.

The reaction sequence of the reactants which takes place in the process of the present invention may be described with reference to FIG. 1, here with two tubular reactors, a heat exchanger and a fixed bed reactor, as follows. A heated stainless steel tube 6, preferably at temperatures of 20° C. to 600° C., more preferably at 300° C. to 500° C. or alternatively at 100° C. to 350° C. is used to meter preheated HF, preferably preheated to 30° C. to 350°C, alternatively 30° C. to 100° C., in gaseous form from an initial charge 1 for reaction with gaseous PCl₃. The gaseous PCl₃ is beforehand transferred in liquid form from initial charge 2 via pump 4 into the vaporizer 5, preferably in a preheated state at between 100° C. and 400° C., more preferably between 200° C. and 350° C., most preferably between 200° C. and 300° C. and mixed therefrom with the HF in stainless steel tube 6 and heated up, preferably to the abovementioned temperatures. The reaction mixture obtained is transferred into stainless steel tube 7 and mixed therein with chlorine from initial charge 3, preferably heated to 20° C. to 400° C., more preferably to 200° C. to 300° C., in an alternative embodiment preferably temperature regulated to −20° C. to 100° C., more preferably to 0° C. to 50° C. and made to react therewith. The resultant PF₅-containing reaction mixture is cooled down by heat exchanger, preferably to −60° C. to 80° C., more preferably to −10° C. to 20° C., and brought into contact with solid LIF or an LiFxHF adduct in fixed bed reactor 9, preferably at temperatures of for example −60° C. to 150° C., preferably between −60° C. to 80° C., more preferably between −10° C. and 20° C., or alternatively at 0° C. to 90° C., preferably by stirring with stirrer 10, or by fluidization or a combination of both. The reaction gas mixture emerging from the fixed bed reactor or fluidized bed reactor 9 is freed of acidic gases in scrubber 11 and the halide-containing solution obtained is transferred into the disposal container 12. The solid product mixture remains in fixed bed reactor/fluidized bed reactor 9 and is partially dissolved there by contacting with the organic solvent and the suspension obtained is separated from the solid material.

The present invention, however, also provides for the use of apparatus comprising the combination of at least two tubular reactors, preferably at least two stainless steel tubes, to prepare PF₅ in combination via at least a heat exchanger with at least a fixed bed reactor or fluidized bed reactor to prepare LiPF₆ from PCl₃, preferably for preparing LiPF₆ solutions. A preferred embodiment employs apparatus comprising two tubular reactors, a heat exchanger and a fixed bed reactor or fluidized bed reactor. Particular preference is given to employing apparatus comprising two tubular reactors, a heat exchanger and a fixed bed reactor.

The present invention, however, also provides a process for preparing PF₅ from PCl₃, characterized in that at least one first tubular reactor is used to react HF with gaseous PCl₃ and at least one second tubular reactor is used to react the resultant reaction mixture with admixed chlorine to form PF₅. in a preferred embodiment, the process is carried out using the combination of two tubular reactors.

### EXAMPLES

In what follows, “%” is always to be understood as meaning wt %. ID is internal diameter.

In relation to the ion chromatography used in the context of the present work, reference may be made to the March 2002 publication of TU Bergakademie Freiberg technical university. Faculty of Chemistry and Physics, Institute of Analytical Chemistry, and also the literature cited therein, and also to Lydia Terhorg, Sascha Nowak, Stefano Passerini, Martin Winter, Uwe Karst, Paul R. Hadad, Pavel N. Nesterenko, analytica Chimica Acta 714 (2012) 121-126.

In the context of the present work, the concentration of hexafluorophosphate and of chloride was measured using an ion chromatograph with the following parameters:

Instrument type: Dionex ICS 2100

column: IonPac® AS20 2*250-mm “Analytical Column with guard”

sample volume: 1 μl

eluent: KOH gradient: 0 min/15 mM, 10 min/15 mM, 13 min/80 mM, 27 min/100 mM, 27.1 min/15 mM, 34 min/15 mM

eluent flow rate: 0.25 ml/min

temperature: 30° C.

Self-Regenerating Suppressor: ASRS® 300 (2-mm)

1. LiPF₆ in DMC/EC Mixture Accordance with the Present Invention)

A mixture of 23 l/h of HF (STP litres) and 0.48 g/min of PCl₃ (both in gaseous form) was passed through a heated, approximately 6 in long stainless steel tube (ID 8 mm) at 450° C. Chlorine was introduced into this reaction mixture at 5.3 l/h, the mixture then passing through a further heated, approximately 4 m long metal tube at 250° C.

The gaseous reaction product was cooled down to −10 to 0° C. and then passed through a stainless steel tube (ID 8 mm) having a diameter of about 18 mm and packed with LiF mouldings (52.2 g). These mouldings have been prepared beforehand by extrusion from a mixture of LiF with water wherein the solids content was about 70% and the mouldings were dried at 120° C. for several days after extrusion.

The gas mixture emerging from this LiF-packed reactor was trapped in an aqueous 15 wt % KOH.

After altogether 4 hours of reaction time, the feed of the reactants was replaced by feeding an inert gas to displace the reactive gas from the system. Then, 446.3 g of a mixture of dimethyl carbonate and ethylene carbonate (1:1 based on the weights used) were recirculated for about 20 hours with a pump through the reactor containing unconverted LiF and the reaction product LiPF₆ to obtain 358.8 g of a reaction mixture, a sample of which was filtered through a syringe filter having a 0.2 μm filter and analysed by ion chromatography. The filtered reaction mixture contained 9.15 wt % of LiPF₆, the chloride content was at the detection limit of <5 ppm.

2. LiPF₆ in Acetonitrile (In Accordance with the Present Invention)

A mixture of 23 l/h of HF and 0.48 g/min of PCl₃ (both in gaseous form) was passed through a heated, approximately 6 m long stainless steel tube (ID 8 mm) at 450° C. Chlorine was introduced into this reaction mixture at 5.3 l/h, the mixture then passing through a further heated, approximately 4 m long stainless steel tube (ID 8 mm) at 250° C.

The reaction product was cooled down to −10 to 0° C. and then passed through a fixed bed reactor having a diameter of about 18 mm and packed with LiF mouldings (359 g). These mouldings have been prepared beforehand by extrusion from a mixture of LiF with water wherein the solids content was about 70% and the mouldings were dried at 120° C. for several days after extrusion.

The gas mixture emerging from this LiF-packed reactor was trapped in an aqueous 15 wt % KOH.

After altogether about 16 hours of reaction time, the feed of the reactants was replaced by feeding an inert gas to displace the reaction gas from the system. Then, 1401 g of acetonitrile dried over molecular sieve were recirculated for about 2 hours with a pump through the reactor containing unconverted LiF and the reaction product LiPF₆ to obtain 1436 g of a reaction mixture, a sample of which was filtered through a syringe filter having a 0.2 μm filter and analysed by ion chromatography. The filtered reaction mixture contained 16.17 wt % of LiPF₆, the chloride content was 67 ppm.

3. LiPF₆ in DMC (In Accordance with the Present Invention)

A mixture of 23 l/h of HF and 0.48 g/min of PCl₃ (both in gaseous form) was passed through a heated, approximately 6 m long stainless steel tube (II) 8 mm) at 450° C. Chlorine was introduced into this reaction mixture at 5.3 l/h, the mixture then passing through a further heated, approximately 4 m long stainless steel tube (ID 8 mm) at 250° C.

The reaction product was cooled down to −10 to 0° C. and then passed through a fixed bed reactor having a diameter of about 18 mm and packed with LiF mouldings (384 g). These mouldings have been prepared beforehand by extrusion from a mixture of LiF with water wherein the solids content was about 70% and the mouldings were dried at 120° C. for several days after extrusion.

The gas mixture emerging from this LiF-packed reactor was trapped in an aqueous 15 wt % KOH.

After altogether about 7 hours of reaction time, the feed of the reactants was replaced by feeding an inert gas to displace the reactive gas from the system. Then, 400 g of dimethyl carbonate were recirculated for about 3 hours with a pump through the reactor containing unconverted LiF and the reaction product LiPF₆ to obtain 306.5 g of a reaction mixture, a sample of which was filtered through a syringe filter having a 0.2 μm filter and analysed by ion chromatography. The filtered reaction mixture contained 32.6 wt % of LiPF₆, the chloride content was 11 ppm.

What is claimed is:

1. Process for preparing LiPF₆ solutions in an organic solvent, or a mixture of two or more organic solvents, proceeding from PCl₃, which is first reacted continuously in the gas phase with HF to form a PF₃-containing reaction mixture which in turn is reacted continuously in the gas phase with Cl₂ initially to form a PCl₂F₃-containing reaction mixture and with additional HF to form a PF₅-containing reaction mixture, characterized in that the PF₅-containing reaction mixture is finally reacted in a fixed bed reactor or fluidized bed reactor over LiF mouldings or with an LiF powder and/or an LiFxHF adduct, and the reaction product is washed with an organic solvent out of the fixed bed reactor or the fluidized bed reactor and isolated.

2. Process according to claim 1, characterized in that the PF₅-containing reaction mixture is temperature regulated to temperatures of −50 to +200° C. before entry into the fixed bed reactor or fluidized bed reactor.

3. Process according to claims 1 or 2, characterized in that LiF mouldings used in the fixed bed reactor or in the fluidized bed reactor are prepared beforehand by extrusion from a mixture of LiF and water wherein the solids content is in the range from 20 to 95 wt % and after extrusion these mouldings are dried at temperatures of 50 to 200° C. and they merely retain a water content of 0.05 to 5 wt %, wherein the water content is determined by the method of Karl Fischer.

4. Process according to claim 3, characterized in that the LiF is employed in the form of mouldings or in the form of fine particles having a particle size distribution in the range from 5 to 500 μm.

5. Process according to claims 1-4, characterized in that the gas mixture emerging from the fixed bed reactor or the fluidized bed is trapped in an aqueous alkali metal hydroxide solution, preferably in a solution of KOH and more preferably in a 5 to 30 wt % KOH solution in water.

6. Process according to claims 1-5, characterized in that the reaction product is dissolved out of the fixed bed reactor or the fluidized bed with an organic solvent or a mixture of two or more organic solvents and separated off.

7. Process according to claim 6, characterized in that the organic solvents used are room temperature liquid organic nitriles or liquid organic carbonates or mixtures thereof and the liquid organic nitrile used is acetonitrile and the liquid organic carbonate used is dimethyl carbonate (DMC) or diethyl carbonate (DEC) or propylene carbonate (PC) or ethylene carbonate (EC) or a mixture of two or more thereof.

8. Process according to claims 6 or 7, characterized in that the organic solvent to be used is subjected before use to a drying process, preferably a drying process over a molecular sieve.

9. Apparatus for preparing LiPF₆ solutions and the intermediate product PF₅ from PCl₃, characterized in that at least two tubular reactors are combined to prepare the PF₅ and are in turn combined with at least a fixed bed reactor or fluidized bed reactor, preferably with a fixed bed reactor, via at least a heat exchanger to prepare the LiPF₆ solutions.

10. Use of apparatus comprising the combination of at least two tubular reactors, preferably at least two stainless steel tubes, to prepare PF₅ in combination via at least a heat exchanger with at least a fixed bed reactor or fluidized bed reactor to prepare LiPF₆ from PCl₃.

11. Use according to claim 10, characterized in that the apparatus employed comprises two tubular reactors, a heat exchanger and a fixed bed reactor or fluidized bed reactor, preferably a fixed bed reactor.

12. Process for preparing PF₅, characterized in that at least one first tubular reactor is used to react HF with gaseous PCl₃ and at least one second tubular reactor is used to react the resultant reaction mixture with admixed chlorine to form PF₅.
